(19) United States
(12) Patent Application Publication
(10) Pub. No.: US 2022/0183353 A1
(43) Pub. Date: Jun. 16, 2022

(54) Combination Hookah and Plasma Light

(71) Applicant: Henry Chung, Walnut, CA (US)

(72) Inventor: Henry Chung, Walnut, CA (US)

(21) Appl. No.: 17/582,498

(22) Filed: Jan. 24, 2022

Related U.S. Application Data
(60) Provisional application No. 63/186,857, filed on May 11, 2021.

(51) Int. Cl. A24F 1/30; A24F 13/00; B03C 3/34; H01T 23/00

(52) U.S. Cl. CPC A24F 1/30; H01T 23/00; B03C 3/34; A24F 13/00

(57) ABSTRACT

A hookah includes a negative ion emitter radiating negative ions into an area around the hookah. Smokers may exhale smoke into the area of the negative ions and the negative ions react with elements in the smoke purifying the surrounding air. An example of a negative ion emitter is a plasma light.

### CROSS-REFERENCE TO RELATED APPLICATIONS

The present application claims the priority of U.S. Provisional Patent Application Ser. No. 63/186,857 filed May 11, 2021, which application is incorporated in its entirety herein by reference.

### BACKGROUND OF THE INVENTION

The present invention relates air freshening and in particular to freshening air around a hookah.

Hookahs are enjoyed world wide as a variation for smoking cigarettes or cigars. The hookahs generally filter smoke though water and allow a group to smoke together from a common hookah. Tobacco used in the hookah may be flavored to provide a pleasant aroma.

Stand alone air cleaners may be positioned in the area of the hookah, but such air fresheners require separate assembly and positioning, and smoke passing through the air fresheners requires periodic cleaning or replacing filters.

Unfortunately, in spite of the advantages provided by a hookah, some members of a group who do not smoke, may object to second hand smoke.

### BRIEF SUMMARY OF THE INVENTION

The present invention addresses the above and other needs by providing a hookah which includes an emitter radiating negative ions around the hookah. Smokers may exhale into the area of the negative ions and the negative ions react with elements purifying the surrounding air.

In accordance with one aspect of the invention, there is provided a hookah including a plasma light providing negative ions. The plasma light preferably is cylindrical and radiates into the area around the hookah. The plasma light is battery powered requiring no cord for operation.

In accordance with another aspect of the invention, there is provided a plasma light requiring no cleaning. Smoke does not pass through the plasma light and no filter is required which would need periodic cleaning or replacing.

In accordance with yet another aspect of the invention, there is provided a method for using a hookah, the method comprising: filling a hookah bowl with tobacco, lighting the tobacco, inhaling smoke from the burning tobacco through a mouthpiece, the smoke passing through a filter in fluid communication between the hookah bowl and the mouthpiece, exhaling the smoke through a negative ion cloud generated by a negative ion emitter proximal to the hookah and surrounding the negative ion emitter, and the ion cloud freshening the smoke. The ionizer is preferably attached to the hookah and the ionizer may be a plasma light.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 shows a smoker using a hookah according to the present invention.

FIG. 2 shows an exploded view of the hookah according to the present invention.

FIG. 3 shows a side view of the hookah according to the present invention.

FIG. 4A shows a front view of the hookah according to the present invention.

FIG. 4B shows a left side view of the hookah according to the present invention.

FIG. 4C shows a right side view of the hookah according to the present invention.

FIG. 4D shows a rear view of the hookah according to the present invention.

FIG. 4E shows a top view of the hookah according to the present invention.

FIG. 4F shows a bottom view of the hookah according to the present invention.

FIG. 5 is a method for using a hookah according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement, or typically within 10 percent of a stated value.

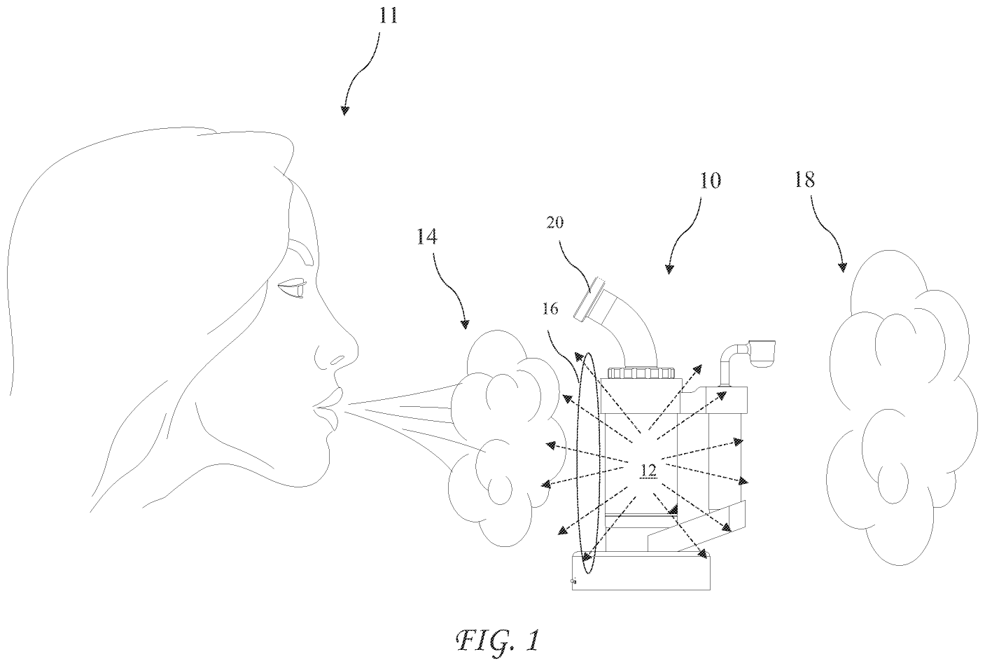

A smoker 11 using a hookah 10 according to the present invention is shown in FIG. 1. The smoker 11 inhales through a mouth piece 20 and exhales smoke 14 toward the hookah. A negative ion emitter (e.g., a plasma light) 12 radiates negative ions 16 into the air around the hookah 10. The smoke 14 is freshened as it passes through the negative ions 16 producing freshened air 18.

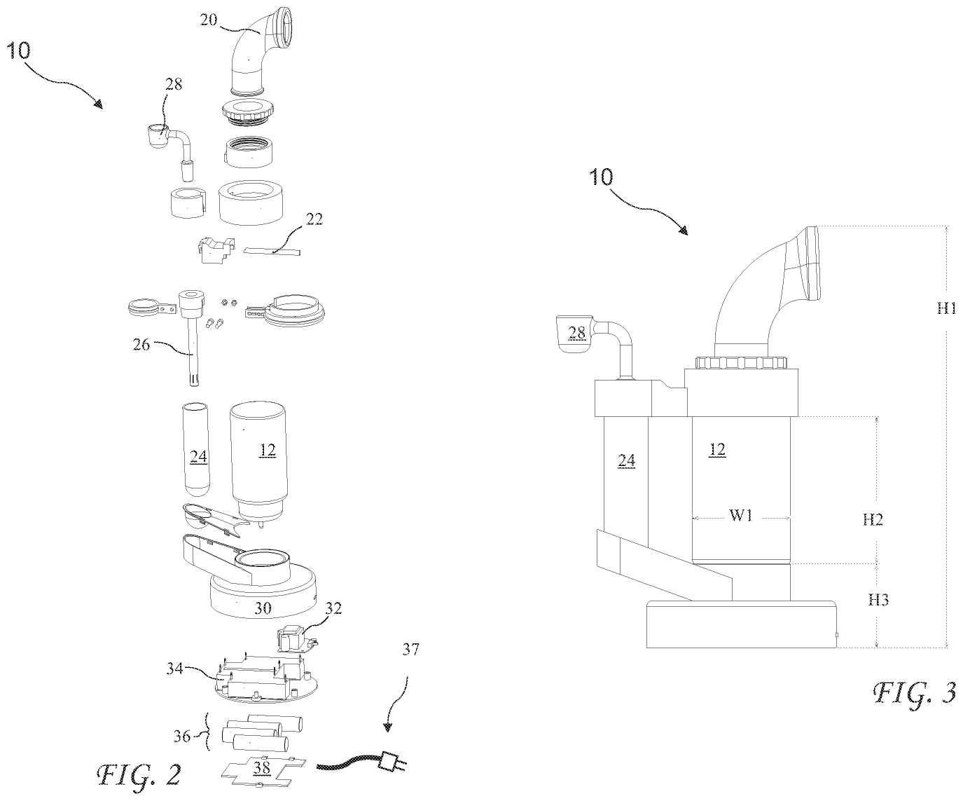

An exploded view of the hookah 10 is shown in FIG. 2. The hookah 10 includes a bowl 28 receiving tobacco or other smoking consumable. A smoker draws smoke from the mouth piece 20 drawing smoke through an air pathway 22. The air pathway 22 draws air from the top of a filter (e.g., a liquid filled test tube, preferably water filled) 24. A vertical air pathway 26 draws smoke from the bowl 28 into the bottom of the filter 24. The hookah 10 is easily disassembled for cleaning the vertical air path 26.

The negative ion emitter 12 is attached to a base 30 of the hookah 10. A Printed Circuit Board (PCB) 32 received a first power signal from batteries 36 in a battery holder 34, and provides a second power signal to the negative ion emitter 12. The PCB 32 may alternatively receive power from a wall outlet through an electrical cord 37. A bottom 38 closes the base 30. The light 12 is preferably a plasma light and is preferably about 67 mm in diameter and 100 mm tall. The negative ion emitter 12 preferably operates on 5 volts and may be a 50 watt plasma light. While a plasma light is a preferred negative ion emitter, those skilled in the art will recognize various plasma or ion generating emitter which also freshen air, and a hookah including such other negative ion emitters are intended to come within the scope of the present invention.

A side view of the hookah 10 is shown in FIG. 3. A portable version of the hookah 10 has an overall height H1 of preferably about 275 mm. The ion emitter 12 has a height H2 of preferably about 100 mm and a width (or diameter) W1 of about 67 mm. The base 30 has a height H3 of preferably about 57 mm. Other hookahs 10 may be larger for use in a hookah bar and any hookah including a negative ion generator is intended to come within the scope of the present invention.

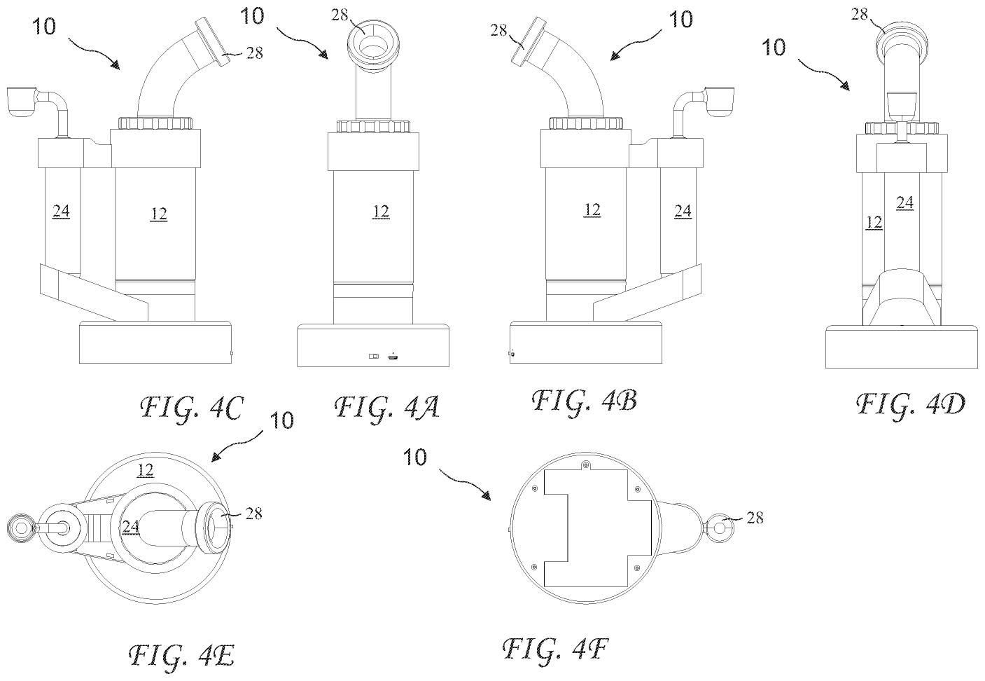

A front view of the hookah 10 is shown in FIG. 4A, a left side view of the hookah 10 is shown in FIG. 4B, a right side view of the hookah 10 is shown in FIG. 4C, a rear view of the hookah 10 is shown in FIG. 4D, a top view of the hookah 10 is shown in FIG. 4E, a bottom view of the hookah 10 is shown in FIG. 4F.

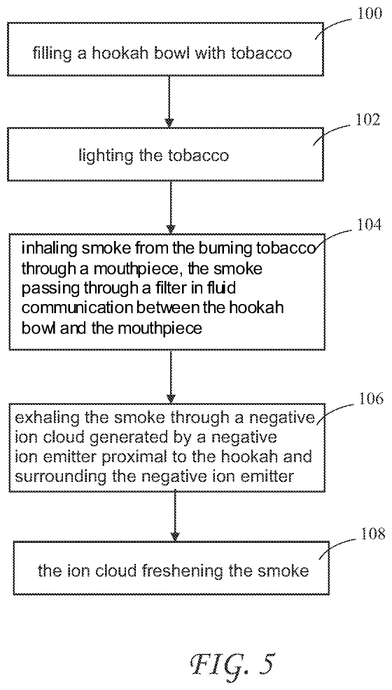

A method of using the hookah 10 is shown in FIG. 5. The method includes, but is not limited to: filling a hookah bowl with tobacco at step 100, lighting the tobacco at step 102, inhaling smoke from the burning tobacco through a mouthpiece, the smoke passing through a filter in fluid communication between the hookah bowl and the mouthpiece, at step 104, exhaling the smoke through a negative ion cloud generated by a negative ion emitter proximal to the hookah and surrounding the negative ion emitter at step 106, and the ion cloud freshening the smoke at step 108.

A particular hookah design with an ion based local air freshening capability is described above, but those skilled in the art will recognize various hookah design and any hookah including an ion based local air freshening capability is intended to come within the scope of the present invention. The ionizer may be attached to the hookah or reside proximal to the hookah, and any combination of a hookah and an ion emitter is intended to come within the scope of the present invention.

While the invention herein disclosed has been described by means of specific embodiments and applications thereof, numerous modifications and variations could be made thereto by those skilled in the art without departing from the scope of the invention set forth in the claims.

I claim:

1. A hookah comprising:
a bowl;
a filter in fluid communication with the bowl;
a mouthpiece for inhaling smoke and in fluid communication with the filter;
a negative ion emitter proximal to the hookah; and
a negative ion cloud generated by the negative ion emitter and surrounding the negative ion emitter.

2. The hookah of claim 1, wherein the filter is a liquid filled filter.

3. The hookah of claim 2, wherein the liquid filled filter is a water filled filter.

4. The hookah of claim 2, wherein the mouthpiece in fluid communication with the filter through a vertical air pathway through the filter.

5. The hookah of claim 1, wherein the negative ion emitter is a plasma light.

6. The hookah of claim 5, wherein the plasma light is a 5 volts 50 watt plasma light.

7. The hookah of claim 1, wherein the negative ion emitter received electrical power from batteries.

8. The hookah of claim 1, wherein the negative ion emitter received electrical power through a power cord.

9. The hookah of claim 1, wherein the negative ion emitter is attached to the hookah.

10. A method for using a hookah, the method comprising:
filling a hookah bowl with tobacco;
lighting the tobacco;
inhaling smoke from the burning tobacco through a mouthpiece, the smoke passing through a filter in fluid communication between the hookah bowl and the mouthpiece;
exhaling the smoke through a negative ion cloud generated by a negative ion emitter proximal to the hookah and surrounding the negative ion emitter; and
the ion cloud freshening the smoke.

11. The method of claim 10, wherein the ionizer is attached to the hookah.

12. The method of claim 10, wherein the ionizer is a plasma light.

13. The hookah of claim 12, wherein the plasma light is a 5 volts 50 watt plasma light.

14. A hookah comprising:
a bowl receiving tobacco;
a filter in fluid communication with the bowl;
a mouthpiece in fluid communication with the filter for a user inhaling smoke produced by burning the tobacco;
a negative ion emitter;
a negative ion cloud generated by the negative ion emitter and surrounding the negative ion emitter;
exhaled smoke by the user passing through the negative ion cloud; and
freshened air flowing from the negative ion cloud.
